(19) United States
(12) Patent Application Publication
(10) Pub. No.: US 2025/0231801 A1
(43) Pub. Date: Jul. 17, 2025

(54) INTELLIGENT CENTRALIZED AGENT FOR AUTONOMOUSLY ORCHESTRATING MULTIPLE DATA TOOLS

(71) Applicant: THE DUN & BRADSTREET CORPORATION, Jacksonville, FL (US)

(72) Inventors: Telmo Felix, Dublin (IE); Pierre Deville, Ottignies (BE); Dory Thibault, Belgique (BE); Seyed Mohammad Nikouei, Hoboken, NJ (US)

(73) Assignee: THE DUN & BRADSTREET CORPORATION, Jacksonville, FL (US)

(21) Appl. No.: 19/097,199

(22) Filed: Apr. 1, 2025

Related U.S. Application Data
(60) Provisional application No. 63/573,010, filed on Apr. 2, 2024.

(51) Int. Cl. G06F 9/50

(52) U.S. Cl. CPC G06F 9/5016

(57) ABSTRACT

An intelligent centralized agent comprising: a dynamic planner; a context short-term memory specific to an interaction session; and at least one data tool that enables the intelligent centralized agent to interact with the application programming interface, the external long-term memory, the machine learning model, and the user interface; wherein the dynamic planner receives input from the application programming interface to make decisions regarding subsequent actions based on the interaction session from the context short term memory, the data tool, and the machine learning model. This unique system provides the intelligent centralized agent with vast access to externally stored data which enables users to resolve questions or queries quickly and reliably in milliseconds.

### CROSS-REFERENCED APPLICATION

This application claims priority to U.S. Provisional Application Ser. No. 63/573,010, filed on Apr. 2, 2024, which is incorporated herein in its entirety by reference thereto.

### BACKGROUND

### 1. Field

An intelligent centralized agent comprising: a dynamic planner; a context short-term memory specific to an interaction session; and a least one data tool that enables the intelligent centralized agent to interact with the application programming interface, the external long-term memory, the machine learning model, and the user interface; wherein the dynamic planner receives input from the application programming interface to make decisions regarding subsequent actions based on the interaction session from the context short term memory, the data tool, and the machine learning model. This unique system provides the intelligent centralized agent with vast access to externally stored data which enables users to resolve questions or queries quickly and reliably in milliseconds.

### 2. Discussion of the Background Art

The inability for a human to consume large amounts of documentation, both internal and external, and combine it with other firmographic data to resolve queries from users is becoming a bigger and bigger problem due to the massive growth in stored and available data. This is particularly difficult in a repeatable, always available form delivered via a user-friendly interface.

This cannot be performed by a user. That is, the quantity of data to parse, the always available nature and a response time measured in milliseconds are not reproducible by users.

Reading all publicly available documents is impractical for a user. It is the object of the present disclosure which seeks to solve the aforementioned problem. Adding such documents to a large language model context greatly improves the accessibility of the information contained within the documents. Furthermore, the trained large language model is capable of simplifying the output and responding to user queries for clarifications. The present inventors have also discovered that by adding firmographic APIs it further improves the relevance.

It is a further object of the present disclosure to combine natural language processing (NLP) and large language models (LLM) with context allowing a transformative user experience. The present disclosure also provides the ability of a user to access, query and understand relevant data, whether from documents or APIs, to enhance the user experience. Furthermore, the present disclosure provides on-the-fly relevant classifications, such that users are guided to the data they need to answer their respective questions or queries. All of this can be accomplished in milliseconds.

Additionally, it is an object of the present disclosure to receive input from an API and make decisions regarding the subsequent actions based on the prevailing context, data tools at its disposal, and available machine learning models. More importantly, conventional workflow systems or simplistic chatbots, the present disclosure operates in a non-pre-determined and fluid manner, adapting to the current and past interactions.

The present disclosure also provides many additional advantages, which shall become apparent as described below.

### SUMMARY

The present disclosure combines an intelligent centralized agent with vast data to allow users to resolve questions or queries quickly and reliably. It facilitates customer use-cases by delivering precisely what they need when they need it through the intelligent centralized agent and removing complexity of data.

A computer system for autonomously and dynamically orchestrating multiple data tools, the computer system comprising: an intelligent centralized agent; an external long-term memory; at least one machine learning model; at least one application programming interface; at least one user interface; wherein the intelligent centralized agent integrates the external long-term memory, machine learning model, application programming interface and user interface for efficient functioning.

The intelligent centralized agent comprises: a dynamic planner; a context short-term memory specific to an interaction session; and at least one data tool that enables the intelligent centralized agent to interact with the application programming interface, the external long-term memory, the machine learning model, and the user interface; wherein the dynamic planner receives input from the application programming interface to make decisions regarding subsequent action based on the interaction session from the context short term memory, the data tool, and the machine learning model.

The interaction session comprises both current interactions and past interactions. The dynamic planner comprises a dynamic workflow that adapts to the current interactions and the past interactions, thereby enabling a more responsive and context-driven decision making.

Additionally, the dynamic planner leverages information stored in the external long-term memory and the context short-term memory, thereby ensuring that decisions are contextually informed and, thus, enhancing the intelligent centralized agent's ability to comprehend and respond to the input or user query from the user interface. The dynamic planner provides for the integration of the machine learning model, the external long-term memory, and the data tool, thereby influencing subsequent interactions of the intelligent centralized agent.

The responses generated by the data tool can dynamically pivot the subsequent interactions of the intelligent centralized agent.

The data tool is at least one selected from the group consisting of: (a) risk tools, (b) environmental, social, and governance tools, (c) match tools, and (d) entity search tools.

The context short-term memory tracks the interactions, thereby enabling the seamless referencing of entities based on previous interactions.

The external long-term memory stores data from at least one database, the database is at least one selected from the group consisting of: data in various formats including tabular and relational databases, analytical databases, vector stores with document embeddings, knowledge base datastores featuring corporate entities and relationships, and recommendation engines mapping share attributes among entities.

The machine learning model is at least one model selected from the group consisting of: large language models, predictive custom models, and classifier custom models. The machine learning model is a large language model which arranges and combine responses from at least two the tools into a coherent answer.

The context short-term memory provides dynamic entitlements based upon queries from the user interface, thereby allowing the intelligent centralized agent to decide what the tools are available and what level of credentials are required to use each the tool.

The intelligent centralized agent uses a combination of the machine learning models, and data from both context short-term memory and the external long-term memory to understand and respond to new and evolving situations.

The system intelligent centralized agent is capable of: (a) learning from examples rather than needing hard-coded rule for every eventuality, (b) making probabilistic decisions based on the data they have rather than failing when faced with unknowns, or (c) continually refine its' knowledge and performance over time.

The dynamic planner can capture a user interaction in the external long-term memory so that it can be used as additional data to guide a query execution plan based not only on one single user context, but on the global set of users' contexts through time. Furthermore, the dynamic planner can cluster a user query or answer thereto, thereby transforming the query into a more precise query via transfer learning: for example, as many more different users of similar role (e.g., marketeer) are asking questions to the system, the details of what is relevant (e.g., customer segmentation) and what is accessory will be recognized as the system evolves, thereby boosting response performance. The dynamic planner captures this through a user feedback loop, like the one described in FIG. 10, i.e., all user interactions are captured on an interaction log that is saved into an interaction database. This user database is then used to feed a machine learning model of user customization where similar questions and answers are grouped together. This is further customized by the roles configurations provided (e.g., marketeer, risk analyzer, credit scorer, etc.) and mixed-in into user profiles that are part of the accessible wherein the user interaction is captured on a interaction log which is saved on an interaction database which feeds said interaction log to said machine learning model of a user customization where similar queries and answers are grouped together, and wherein said user interaction is further customized by the roles configurations and mixed into a user profile in the external long-term memory of the intelligent centralized agent.

A method that autonomously and dynamically orchestrating multiple data tools, the method comprising: a user generating a query via a user interface and inputting the query into an intelligent centralized agent; and selecting at least one data tool which enable said intelligent centralized agent to integrate with an external long-term memory, a machine learning model, an application programming interface and/or the user interface for efficient functioning.

Further objects, features and advantages of the present disclosure will be understood by reference to the following drawings and detailed description.

### BRIEF DESCRIPTION OF THE DRAWINGS

FIG. 1 is a block diagram according to the present disclosure depicting the relationship between the intelligent agent and various users, data stores, custom, pre-trained and large language models, and application programming interface (APIs);

FIG. 2 is a block diagram of a computer system's component level configuration depicting the dynamic planner serving as the central coordination component of the intelligent centralized agent, seamlessly integrating all other components for efficient functioning;

FIG. 3 is a flow diagram of the dynamic coordination of the dynamic planner in orchestrating complex interactions within the intelligent centralized agent's framework;

FIG. 4 is a flow chart describing the steps that occur when a user makes a query, and showing how each component, (i.e., tools, contextual memory, external memory, etc.) is integrated so that two tools are called in sequence to generate an answer;

FIG. 5 is a flow chart describing an example where it uses the context to answer either positively or negatively to a question;

FIG. 6 is a flow chart describing an example where it uses specific information on the question to use a specific tool and not a generic one;

FIG. 7 is a block diagram which describes how the novel combination of the various components of the computer system's component level configuration of FIG. 2 leverages models like large language models and context to make decisions;

FIG. 8 depicts a conventional system which requires explicit instructions for every scenario it might encounter because it is restricted to a strict set of rules and a static set of paths for every interaction;

FIG. 9 is a flow diagram of the dynamic coordination of the dynamic planner of the present disclosure which allows each interaction to be different and the system leverages the data to execute dynamic coordination of its components;

FIG. 10 is a block diagram of the present disclosure which depicts how the dynamic context on the use of hardware with human feedback loop, i.e., taking in account the role of the user making the question; and

FIG. 11 is a diagram which clusters users on questions/answers according to the dynamic coordination, wherein the intelligent agent of the present disclosure increases the accuracy of the system as then number of users and number of questions processed increase using transfer learning.

### DETAILED DESCRIPTION OF THE PREFERRED EMBODIMENT

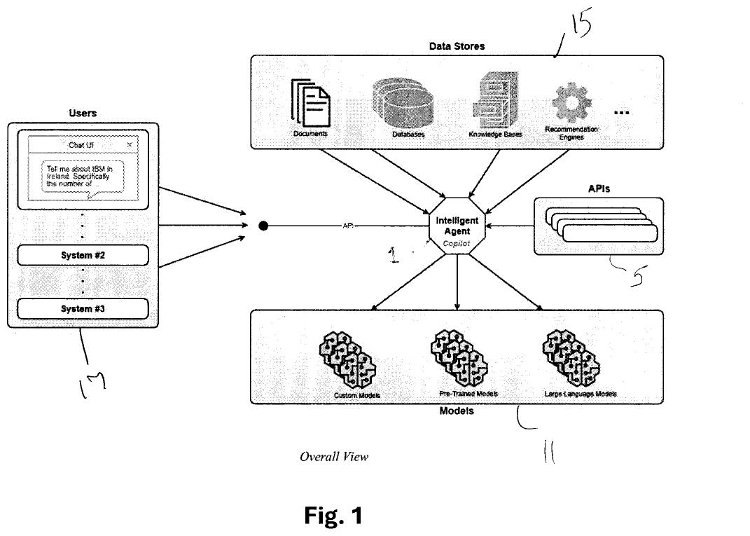

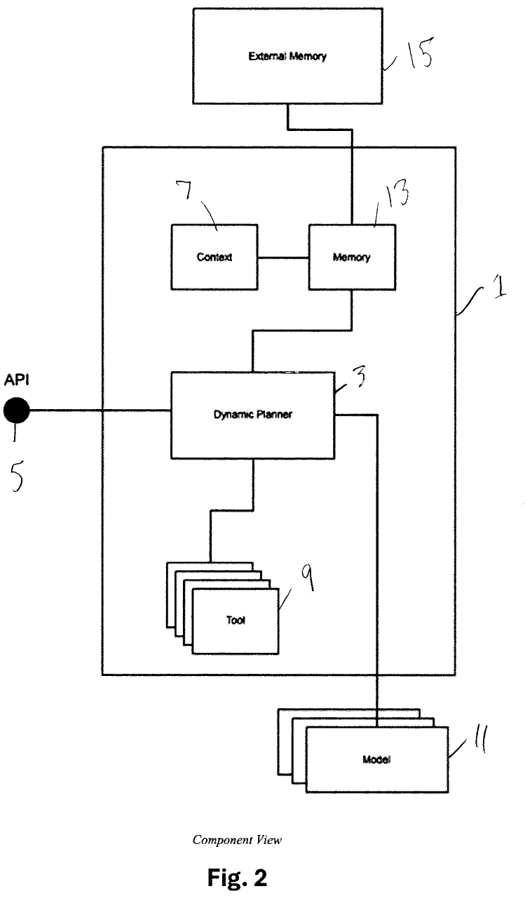

The present disclosure can best be understood by referring to the figures. In particular, FIGS. 1 and 2 disclose a system comprising an intelligent centralized agent 1 comprising various components designed to enhance its capabilities. These components include:

### Dynamic Planner

The dynamic planner 3 serves as the central coordination component of the agent 1, seamlessly integrating all other components for efficient functioning.

Operational Workflow: dynamic planner 3 receives input from an API 5 and makes decisions regarding the subsequent actions based on the prevailing context 7, tools 9 at its disposal, and available machine learning models 11. Unlike conventional workflow systems or simplistic chatbots, this dynamic planner 3 operates in a non-pre-determined and fluid manner, adapting to the current and past interactions.

### Key Features:

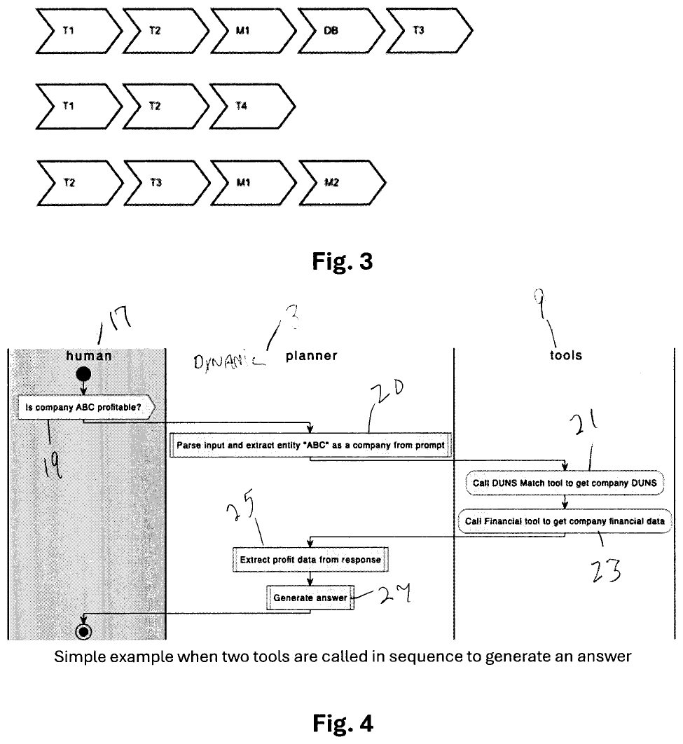

1. Adaptive Workflow: The workflow of the present disclosure is not static but rather adapts dynamically to the ongoing and previous interactions. This adaptability distinguishes it from conventional workflow structures, enabling a more responsive and context-aware approach.
2. Context-Driven Decision Making: dynamic planner 3 leverages information stored in short-term memory 13 and external long-term memory 15, considering both short-term and long-term aspects. This ensures that decisions are contextually informed, enhancing agent 1's ability to comprehend and respond effectively to user queries from user interface 17.
3. Tool and Model Integration: It integrates seamlessly with the various tools 9 and machine learning models 11 available to agent 1. This integration allows dynamic planner 3 to utilize the outputs from tools 9, such as risk assessments or entity searches, to influence subsequent actions. An illustrative example is provided in FIG. 3.
4. Response Pivots: Responses generated by tools 9 can dynamically pivot the subsequent actions of agent 1. For instance, the outcome of a risk assessment tool may prompt a shift.

For a visual representation of this dynamic coordination, refer to FIG. 3. This adaptability and integrative approach underscore the sophistication of dynamic planner 3 in orchestrating complex interactions within agent's 1 framework.

### Tools

Tools 9 are components which enable agent 1 to interact with its external environment. They facilitate access to external APIs 5, such as REST APIs, and are domain-specific in nature. Examples of these tools 9 include:
Risk Tool: This tool provides the risk profile and risk indicators for a given company.
ESG Tool: Offering insight into the Environmental, Social, and Governance characteristics of an entity.
Match Tool: Identifying a DUNS number associated with a given entity.
Company Search Tool: Conducting searches within the dataset using specified criteria and returning a list of entities meeting the criteria.

### Memory

Agent 1 possesses memory 13, 15 to maintain state and facilitate interactions with user interface 17. Memory is divided into two parts: short-term memory 13 specific to an interaction session, and long-term memory 15 serving as a knowledge base for agent 1.

### Context (Short-Term Memory)

Short-term memory 13 keeps track of interactions, enabling the referencing of entities (e.g., a company) based on previous interactions. For instance, if a user 17 requests information about companies in Detroit and later seeks revenue details for a specific company, the context allows seamless referencing.

### External (Long-Term Memory)

Long-term memory 15 encompasses all available external data in various formats, functioning as a repository of expertise for agent 1. Accessible in different formats, including tabular and relational databases, analytical databases, vector stores with document embeddings, knowledge base datastores featuring corporate entities and relationships, and recommendation engines mapping shared attributes among companies.

### ML Models

Agent 1 leverages diverse machine learning models 11 for different functionalities:
LLMs (Large Language Models): The use of large language models enables agent 1 to provide a conversational interface and effectively handle natural language processing. Multiple LLM models can be employed for specific functionalities or fine-tuned for particular domains, such as sales and marketing or risk use cases.
Predictive Custom Models: In addition to LLMs, agent 1 utilizes custom models, such as predictive models. These models offer suggestions based on features like company location, revenue, industry, and risk scores, predicting the behavior of a new company under similar conditions.
Classifier Custom Models: custom classification models, utilizing data, aid in decision-making processes such as portfolio segmentation.

FIG. 4 provides a simple example when two tools 9 are called in sequence to generate an answer. That is, FIG. 4 provides an end-to-end example describing the steps that occur when a user (i.e., a human) via user interface 17 makes a query to dynamic planner 3, and shows how each component (i.e., tools 9, contextual short-term memory (7,13), and external long-term memory 15, etc.) is integrated.

That is, when the user submits a question or query 19, such as “is company ABC profitable?”, via user interface 17 to dynamic planner 3 which parses the input or query and extracts entity “ABC” as a company from prompt 20. After the entity “ABC” is extracted from user's query by dynamic planner 3, the system uses, for example, a matching tool 21 to get ABC's DUNS Number and a financial tool 23 seeking financial data on entity ABC. Once the financial data is retrieved via financial tool 23, the financial data is then inputted back into dynamic planner 3 to extract profit data 25 therefrom and, thus, generating answer 27 in response to user's initial query and returns answer 27 to user interface 17.

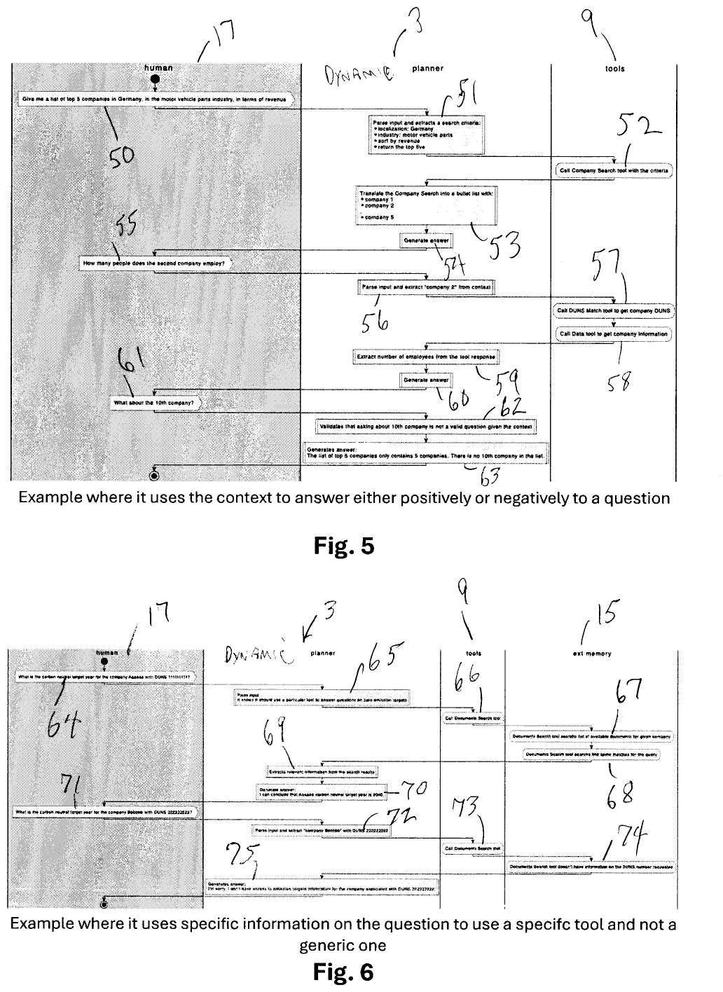

FIG. 5 demonstrates an example according to the present disclosure, wherein the system uses specific information on the query from user interface 17 to use a specific tool 9 and not a generic tool. Herein, user generates a query 50, i.e., “Give me a list of top 5 companies in Germany, in the motor vehicle parts industry, in terms of revenue”. Query 50 is then inputted into dynamic planner 3 which parses the input and extracts a search criteria 51, e.g., (i) localization: German, (ii) industry: motor vehicle parts, (iii) sort by revenue, and (iv) return the top five. The system then calls a company search tool 52 with search criteria 51. Company search tool 52 then generates answer 53 (e.g., translate the company search into a bullet list with: company 1, company 2 . . . company 5) which is sent back to dynamic planner 3 to generate answer 54. Thereafter, the user responds to answer 54 by asking another question 55, e.g., how many people does the second company employ?

The second question 55 is then input back into dynamic planner 3 which parses the input and extracts “company 2” from context 56 and is inputted into tools 9 which calls DUNS Matching tool 57 to get company 2's DUNS number. Tools 9 then calls data tool 58 to get company 2's information which is sent to dynamic planner 3 to extract number of employees from data tool's 58 response 59. The answer is generated 60. User then sends another query 61 via user interface 17 (i.e., What about the 10^{th} company?). However, dynamic planner 3 recognizes that query 61 is not a valid question 62 given the context to the prior queries 50 and 55. Thus, dynamic planner 3 generates an answer 63, e.g., the list of top 5 companies only contains 5 companies. There is no 10^{th} company in the list and returns this answer to user interface 17.

FIG. 6 is another example where it uses specific information on the question to use a specific tool and not a generic tool. User via user interface 17 generates a query 64, e.g., What is the carbon neutral target year for the company Aaaaaa with DUNS No. 111111111? Query 64 is then inputted to dynamic planner 3 to parse input 65 while it knows that it should use a particular tool for zero emissions targets. Therefore, tool 9 calls for a document search tool 66 from extended long-term memory 15 which uses a document search tool which searches a list of available documents for a given company 67, such as Aaaaaa. Thereafter, the documents search tool then searches for some matches for the query 68. Then dynamic planner 3 extracts relevant information from the search results 69 from query 68, and then generates an answer 70, i.e., I can conclude that Aaaaaa carbon neutral target year is 2040.

User generates a second query 71 after receiving answer 70 from dynamic planner 3. Query 71 states “What is the carbon neutral target year for the company Bbbbbb with Duns No. 2222222222? Query 71 is then sent back to dynamic planner 3 where it is parsed and extracts “company Bbbbbb” with Duns No. 2222222222 (72). Thereafter, parsed and extracted query is sent to tools 9 which calls for documents search tool 73 from extended long-term memory 15 which uses a document search tool which searches a list of available documents for a given company, such as Bbbbbb. Thereafter, the documents search tool then searches for some matches for query 71. The result is that documents search tool doesn't have information on the DUNS number 2222222222 (74) which is sent back to dynamic planner 3 which generates the following answer, i.e., I'm sorry, I don't have access to emission targets information for the company associated with DUNS number 2222222222 (75).

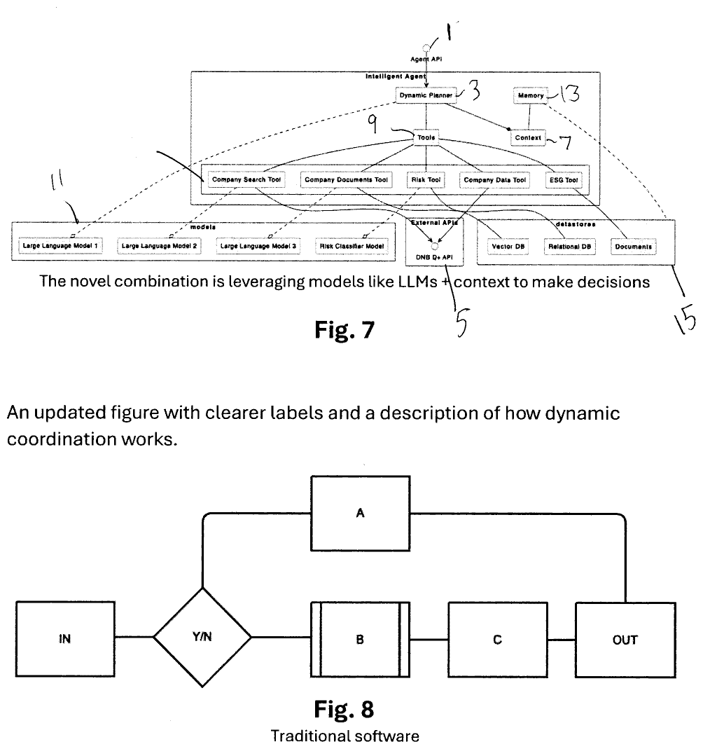

FIG. 7 is a block diagram which demonstrates how dynamic coordination works according to the present disclosure. It provides a full discussion of the “Component View” highlighting novel aspects of the hardware configuration.

The novel combination is leveraging models like LLMs 11 and context 7 to make decisions. Tools 9 can be components (e.g., clients to external APIs, database clients, etc.) that know how to do a specific job. Tools 9 can also be hybrids, in the sense they leverage some artificial intelligence models having capabilities likes the Natural Language Processing or Code Generation (e.g., to generate SQL statement on-the-fly) or extract information in a human readable format from a machine generated response.

Dynamic planner 3 or coordinator leverages context 7 (i.e., the state of the interactions) and the current request with the help of an LLM to dynamically invoke the required tool or set of tools. It also uses the LLM model to arrange and combine the responses from the different tools into a coherent answer.

The Another thing context 7 could provide is dynamic entitlements, i.e., based on the user or client that is calling API 5 it could decide what tools 9 are available and what level of credentials to use on each tool.

The composition of various components and leveraging models, such as LLM, is what allows the dynamic and adaptive aspect of the solution of the present disclosure.

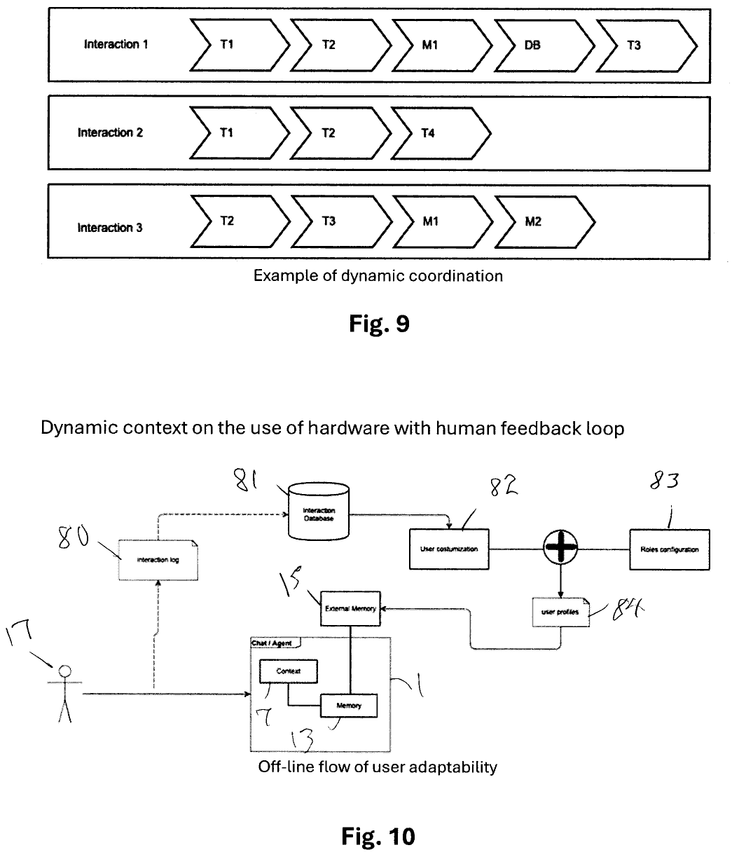

FIG. 9 is an example of dynamic coordination according to the present disclosure. FIG. 8 is an example of a conventional process which requires explicit instructions for every possible scenario it might encounter. It can have decision points (e.g., conditionals) but is always restricted to a strict set of rules and a static set of paths for every interaction. For complex tasks or those in dynamic environments, encoding the combinations is often impractical, if not impossible.

In contrast, FIG. 9 shows intelligent centralized agent 1 according to the present disclosure which is used in a combination of learning algorithms and data to understand and respond to new and evolving situations so that the system can:
Generalize from Data: They can learn from examples rather than needing hard-coded rules for every eventuality.
Handle Uncertainty: They can make probabilistic decisions based on the data they have, rather than failing when faced with unknowns.
Continuous Improve: As they encounter more data, they can refine their knowledge and performance, continually improving over time.

For example, above in FIG. 8 with conventional systems one could either take the Yes or No path but it does not matter how many interactions we have, those would be the only two available paths. Adding new paths implies changing the system and increasing the complexity. It also means that the paths need to be thought about upfront.

With intelligent centralized agent 1 approach according to the present disclosure, each interaction can be different and the system leverages the data to execute dynamic coordination of its components.

For the example above in FIG. 9 we can see that:
for the first interaction the flow executed a sequence of tools (e.g., T1 and T2) followed by use of a Model (M1), accessing a database (DB) and finally calling another tool (e.g., T3).
for the second interaction, the flow was simple a sequence of tools (e.g., T1, T2, T4)
for the third interaction, the flow was a sequence of tools (e.g., T2 and T3) followed by the use of two models (e.g., M1 and M2)

Because the data can also be either local to the interaction (i.e., user session/context) or reside out-of-band and be updated continuously (e.g., external data store 15 like a relational database or a documents store) it also means that the interactions can also change over time, i.e., one interaction that might have three steps today might take five steps tomorrow if additional data is present, that was not there before.

FIG. 10 depict a flow diagram demonstrating dynamic context on the use of hardware with human feedback loop according to the present disclosure. That is, FIG. 10 depicts an off-line flow of user adaptability, wherein dynamic planner 3 already has the capability to leverage context 7 (i.e., the state of the interactions) and the current request with the dynamically invoke of the required tool or set of tools, taking in account the role of the user making the question. That, by itself, is better than the conventional static workflow approach to interactions. But still suffers from lack of adaptation to the types of users asking the questions and how the users are asking the questions.

The dynamic planner captures this through a user feedback loop, like the one described in FIG. 10, i.e., all user interactions are captured on an interaction log 80 that is saved into an interaction database 81. This user database is then used to feed a machine learning model of user customization 82 where similar questions and answers are grouped together. This is further customized by the roles configurations provided (e.g., marketeer, risk analyzer, credit scorer, etc.) and mixed-in into user profiles 84 that are part of the accessible wherein the user interaction is captured on a interaction log which is saved on an interaction database which feeds said interaction log to said machine learning model of a user customization where similar queries and answers are grouped together, and wherein said user interaction is further customized by the roles configurations and mixed into a user profile in the external long-term memory of the intelligent centralized agent.

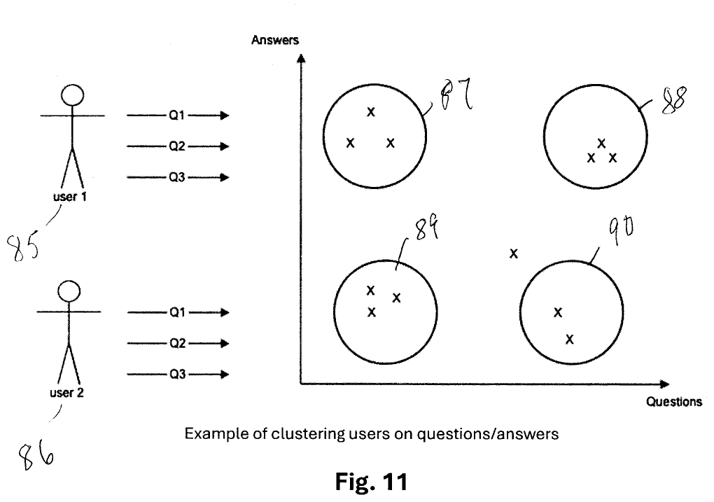

The extra step is to capture the user interactions 80 into an interaction database 81 that is then used as additional data to provide user customization 82 and roles configuration 83 to generate a under profile 84 which is inputted into external long-term memory 15 for use by intelligent centralized agent 1. This serves to guide the query execution plan not only based on a local, only one user context 7, but on a global, set of users' context 7 through time. This is a similar use of the traditional database statistics tables, where with each query, the execution plan is updated to give each time a better answer (either in accuracy or number of steps required) than before. For example, in FIG. 11 we can see that two users 85 and 86, respectively, have been using the system, and have been doing a suitable number of questions,

Those questions and answers, coming from typical use cases that the users 85 and 86 might be doing day-in-day-out, e.g., handling suppliers for their company or assessing risk, might be aggregated by similarity (on FIG. 11 we see there are four of those use cases 87, 88, 89, 90). If now, a question does not match one of the clusters, but is close to an existing one (e.g., below on the bottom right cluster), we can transform the question into a more precise one (using for example transfer learning).

This means the system, will be improving as time goes by, and as the number of users and number of questions processed increase, the accuracy of the system also increases.

While we have shown and described several embodiments in accordance with our invention, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A computer system for autonomously and dynamically orchestrating multiple data tools, said computer system comprising:
an intelligent centralized agent;
an external long-term memory;
at least one machine learning model;
at least one application programming interface; and
at least one user interface;
wherein said intelligent centralized agent integrates said external long-term memory, machine learning model, application programming interface and user interface for efficient functioning.

2. The system according to claim 1, wherein said intelligent centralized agent comprises:
a dynamic planner;
a context short-term memory specific to an interaction session; and
at least one said data tool that enables the intelligent centralized agent to interact with said application programming interface, said external long-term memory, said machine learning model, and said user interface;
wherein said dynamic planner receives input from said application programming interface to make decisions regarding subsequent action based on said interaction session from said context short term memory, said data tool, and said machine learning model.

3. The system according to claim 2, wherein said interaction session comprises both current interactions and past interactions.

4. The system according to claim 3, wherein dynamic planner comprises a dynamic workflow that adapts to said current interactions and said past interactions, thereby enabling a more responsive and context-driven decision making.

5. The system according to claim 4, wherein said dynamic planner leverages information stored in said external long-term memory and said context short-term memory, thereby ensuring that decisions are contextually informed and, thus, enhancing the intelligent centralized agent's ability to comprehend and respond to said input or user query from said user interface.

6. The system according to claim 2, wherein said dynamic planner provides for the integration of said machine learning model, said external long-term memory, and said data tool, thereby influencing subsequent interactions of said intelligent centralized agent.

7. The system according to claim 6, wherein responses generated by said data tool can dynamically pivot said subsequent interactions of said intelligent centralized agent.

8. The system according to claim 2, wherein said data tool is at least one selected from the group consisting of: (a) risk tools, (b) environmental, social, and governance tools, (c) match tools, and (d) entity search tools.

9. The system according to claim 2, wherein said context short-term memory tracks said interactions, thereby enabling the seamless referencing of entities based on previous interactions.

10. The system according to claim 1, wherein said external long-term memory stores data from at least one database, said database is at least one selected from the group consisting of: data in various formats including tabular and relational databases, analytical databases, vector stores with document embeddings, knowledge base datastores featuring corporate entities and relationships, and recommendation engines mapping share attributes among entities.

11. The system according to claim 1, wherein said machine learning model is at least one model selected from the group consisting of: large language models, predictive custom models, and classifier custom models.

12. The system according to claim 2, wherein said machine learning model is a large language model which arranges and combine responses from at least two said data tools into a coherent answer.

13. The system according to claim 2, wherein said context short-term memory provides dynamic entitlements based upon queries from said user interface, thereby allowing said intelligent centralized agent to decide what said data tools are available and what level of credentials are required to use each said data tool.

14. The system according to claim 2, wherein said intelligent centralized agent uses a combination of said machine learning models, and data from both context short-term memory and said external long-term memory to understand and respond to new and evolving situations.

15. The system according to claim 14, wherein said intelligent centralized agent is capable of: (a) learning from examples rather than needing hard-coded rule for every eventuality, (b) making probabilistic decisions based on the data they have rather than failing when faced with unknowns, or (c) continually refine its' knowledge and performance over time.

16. The system according to claim 2, wherein said dynamic planner is capable of capturing a user interaction in said external long-term memory so that it can be used as additional data to guide a query execution plan only based on only one user context, but on a global set of users' context through time.

17. The system according to claim 2, wherein said dynamic planner can cluster a user query or answer thereto, thereby transforming said query into a more precise query via transfer learning, thereby boosting response performance as the system evolves.

18. The system according to claim 17, wherein said dynamic planner generates a user feedback loop, wherein user interactions are captured on a interaction log which is saved on an interaction database which feeds said interaction log to said machine learning model of a user customization where similar queries and answers are grouped together, and wherein said user interaction is further customized by the roles configurations and mixed into a user profile in said external long-term memory of said intelligent centralized agent.

19. A method that autonomously and dynamically orchestrating multiple data tools, said method comprising:
a user generating a query via a user interface and inputting said query into an intelligent centralized agent; and
selecting at least one said data tool which enable said intelligent centralized agent to integrate with an external long-term memory, a machine learning model, an application programming interface and/or said user interface for efficient functioning.

20. The method according to claim 19, wherein said intelligent centralized agent comprises:
a dynamic planner;
a context short-term memory specific to an interaction session; and
at least one said data tool that enables the intelligent centralized agent to interact with said application programming interface, said external long-term memory, said machine learning model, and said user interface;
wherein said dynamic planner receives input from said application programming interface to make decisions regarding subsequent action based on said interaction session from said context short term memory, said data tool, and said machine learning model.

21. The method according to claim 20, wherein said interaction session comprises both current interactions and past interactions.

22. The method according to claim 21, wherein dynamic planner comprises a dynamic workflow that adapts to said current interactions and said past interactions, thereby enabling a more responsive and context-driven decision making.

23. The method according to claim 22, wherein said dynamic planner leverages information stored in said external long-term memory and said context short-term memory, thereby ensuring that decisions are contextually informed and, thus, enhancing the intelligent centralized agent's ability to comprehend and respond to said input or user query from said user interface.

24. The method according to claim 20, wherein said dynamic planner provides for the integration of said machine learning model, said external long-term memory, and said data tool, thereby influencing subsequent interactions of said intelligent centralized agent.

25. The method according to claim 24, wherein responses generated by said data tool can dynamically pivot said subsequent interactions of said intelligent centralized agent.

26. The method according to claim 20, wherein said data tool is at least one selected from the group consisting of: (a) risk tools, (b) environmental, social, and governance tools, (c) match tools, and (d) entity search tools.

27. The method according to claim 20, wherein said context short-term memory tracks said interactions, thereby enabling the seamless referencing of entities based on previous interactions.

28. The method according to claim 19, wherein said external long-term memory stores data from at least one database, said database is at least one selected from the group consisting of: data in various formats including tabular and relational databases, analytical databases, vector stores with document embeddings, knowledge base datastores featuring corporate entities and relationships, and recommendation engines mapping share attributes among entities.

29. The method according to claim 19, wherein said machine learning model is at least one model selected from the group consisting of: large language models, predictive custom models, and classifier custom models.

30. The method according to claim 20, wherein said machine learning model is a large language model which arranges and combine responses from at least two said data tools into a coherent answer.

31. The method according to claim 20, wherein said context short-term memory provides dynamic entitlements based upon queries from said user interface, thereby allowing said intelligent centralized agent to decide what said data tools are available and what level of credentials are required to use each said tool.

32. The method according to claim 20, wherein said intelligent centralized agent uses a combination of said machine learning models, and data from both context short-term memory and said external long-term memory to understand and respond to new and evolving situations.

33. The method according to claim 15, wherein said intelligent centralized agent is capable of: (a) learning from examples rather than needing hard-coded rule for every eventuality, (b) making probabilistic decisions based on the data they have rather than failing when faced with unknowns, or (c) continually refine its' knowledge and performance over time.

34. The method according to claim 20, wherein said dynamic planner is capable of capturing a user interaction in said external long-term memory so that it can be used as additional data to guide a query execution plan only based on only one user context, but on a global set of users' context through time.

35. The method according to claim 20, wherein said dynamic planner can cluster a user query or answer thereto, thereby transforming said query into a more precise query via transfer learning, thereby boosting response performance as said system evolves.

36. The method according to claim 21, wherein said dynamic planner generates a user feedback loop, wherein user interactions are captured on a interaction log which is saved on an interaction database which feeds said interaction log to said machine learning model of a user customization where similar queries and answers are grouped together, and wherein said user interaction is further customized by the roles configurations and mixed into a user profile in said external long-term memory of said intelligent centralized agent.
